(19) United States
(12) Patent Application Publication
(10) Pub. No.: US 2026/0010558 A1
(43) Pub. Date: Jan. 8, 2026

(54) GENERATING EMBEDDINGS AND EXTRACTING CONTENT ATTRIBUTES FROM LONG DOCUMENTS USING ARTIFICIAL INTELLIGENCE

(71) Applicant: HULU, LLC, Santa Monica, CA (US)

(72) Inventors: Vahidreza Arbab, Los Angeles, CA (US); Tuo Li, Irvine, CA (US); Yavuz Sunor, Los Angeles, CA (US)

(73) Assignee: HULU, LLC, Santa Monica, CA (US)

(21) Appl. No.: 19/044,507

(22) Filed: Feb. 3, 2025

Related U.S. Application Data
(60) Provisional application No. 63/668,145, filed on Jul. 5, 2024.

(51) Int. Cl. G06F 16/35; G06F 40/103

(52) U.S. Cl. CPC G06F 16/35; G06F 40/103

(57) ABSTRACT

A method includes determining embeddings in an embedding space for segments of a plurality of documents. A cluster is determined for respective segments based on a set of clusters. The cluster is determined based on a position of respective embeddings in the embedding space. The method determines a weight for the cluster for respective embeddings. The respective embeddings are weighted for a document in the plurality of documents using the weight of the cluster for the respective embeddings to generate weighted embeddings. A set of attributes from the weighted embeddings is determined for the document.

### CROSS REFERENCE TO RELATED APPLICATIONS

Pursuant to 35 U.S.C. § 119(e), this application is entitled to and claims the benefit of the filing date of U.S. Provisional App. No. 63/668,145 filed Jul. 5, 2024, entitled “CONTENT ATTRIBUTE EXTRACTION USING ARTIFICIAL INTELLIGENCE”, the content of which is incorporated herein by reference in its entirety for all purposes.

### BACKGROUND

A content delivery service may have a database of multiple instances of content, such as movies, shows, etc. Metadata for content may be used by a company to provide services. The metadata may describe attributes of the content. The instances of content may be associated with screenplays, which may include character dialogue and other information, such as action statements. The screenplays may include complex characteristics in which the extraction of metadata from the screenplays that correctly describes attributes of the content may be difficult and resource intensive, and also include bias.

### BRIEF DESCRIPTION OF THE DRAWINGS

The included drawings are for illustrative purposes and serve only to provide examples of possible structures and operations for the disclosed inventive systems, apparatus, methods, and computer program products. These drawings in no way limit any changes in form and detail that may be made by one skilled in the art without departing from the spirit and scope of the disclosed implementations.

FIG. 1 depicts a simplified system for analyzing instances of content according to some embodiments.

FIG. 2 depicts a more detailed example of a classifier according to some embodiments.

FIG. 3 depicts a more detailed example of a sentence encoder according to some embodiments.

FIG. 4 depicts a simplified flowchart of the weighting process according to some embodiments.

FIG. 5 depicts a simplified flowchart of an example using the embeddings for determining semantic relationships according to some embodiments.

FIG. 6 depicts a simplified flowchart for training the system according to some embodiments.

FIG. 7 depicts a simplified flowchart for training model parameters of system according to some embodiments.

FIG. 8 illustrates one example of a computing device according to some embodiments.

### DETAILED DESCRIPTION

Described herein are techniques for an extraction system. In the following description, for purposes of explanation, numerous examples and specific details are set forth to provide a thorough understanding of some embodiments. Some embodiments as defined by the claims may include some or all the features in these examples alone or in combination with other features described below, and may further include modifications and equivalents of the features and concepts described herein.

### System Overview

A system decodes a document to automatically extract attributes that describe the document. For example, the document may include text that is associated with instances of content. In some embodiments, screenplays that include text for media content (e.g., movies, shows, etc.) may be analyzed, and the system extracts attributes that describe the respective screenplays. The screenplays may be long textual documents that may be organized in portions, such as scenes. A scene may be a specific portion of the screenplay where a particular event or action may take place. In some examples, the scene may serve a narrative purpose for the media content. The term screenplay may be used for discussion purposes, but other types of documents may be appreciated, such as transcripts, books, emails, lyrics, poems, papers, etc.

The system may analyze multiple documents. Each document may be divided into smaller segments. Then, the system calculates embeddings for each segment. The system may perform clustering of the embeddings for all the documents to categorize each embedding in a cluster. Then, the system may weight the clusters, such as using an inverse document frequency weighting. Here, clusters that may be very common or very rare may be weighted lower because these clusters may not contribute significantly to the inference of determining attributes for the documents. The system applies the weights for the respective clusters in which embedding are assigned to the respective embeddings to form weighted embeddings. Then, the weighted embeddings may be classified into attributes for the documents. In some embodiments, the attributes may describe aspects of the screenplay, such as different attributes in category types of genres, plot, mood, attitudes, places, etc. In some examples, the attributes for a screenplay may be a genre of drama, an attitude of sarcastic, and a plot of a narrative.

The above system may improve the classification of the attributes for the documents. The use of clustering may better capture the attributes of portions of the document. For example, the weighted embeddings may better capture a representation of important scenes in the screenplay. This causes the classification to be more representative of the screenplay or capture nuances in scenes. For example, the system facilitates a detailed analysis that captures emotional, and genre shifts throughout content, such as a movie, providing deep insights into the content structure and narrative dynamics that were previously difficult to achieve. Such granularity of analysis is invaluable in offering a deeper understanding of the intricacies of screenplay writing and film production. The ability to understand and predict content flow is crucial, especially when considering the need to insert supplemental content within movies and TV series efficiently. The attributes that are determined enable supplemental content placement in the most contextually relevant and non-intrusive moments, enhancing viewer experience while optimizing supplemental content effectiveness and engagement. The use of clustering makes it possible to assign importances to the individual scenes within the corpus of documents (e.g., all the scenes among the all screenplays). For example, scenes from different screenplays find subtle relationships (weights based on inverse document frequency) among each other based on whether or not they are assigned to the same clusters. As the attributes are known for the screenplays (rather than the scenes), these subtle relationships contribute to the final embeddings of the screenplays that goes into the classifier. As the same embedding space (the fixed dimensions of the same vector space) applies both to scenes and screenplay, the learning can then be transferred to scenes.

In some embodiments, the system may use pre-trained language models for generating the initial embeddings of segments. This significantly reduces the computational burden and the necessity for extensive hardware, setting the system apart from traditional approaches that depend on laborious training phases of deep learning models. Consequently, the system is not only more efficient but also accessible, requiring less computational resources. However, custom training of the models may also be performed to optimize parameters of the models. Instead, the system may train parameters for the clustering process and also a multi-label classifier that determines the attributes, which will be described in more detail below.

### System

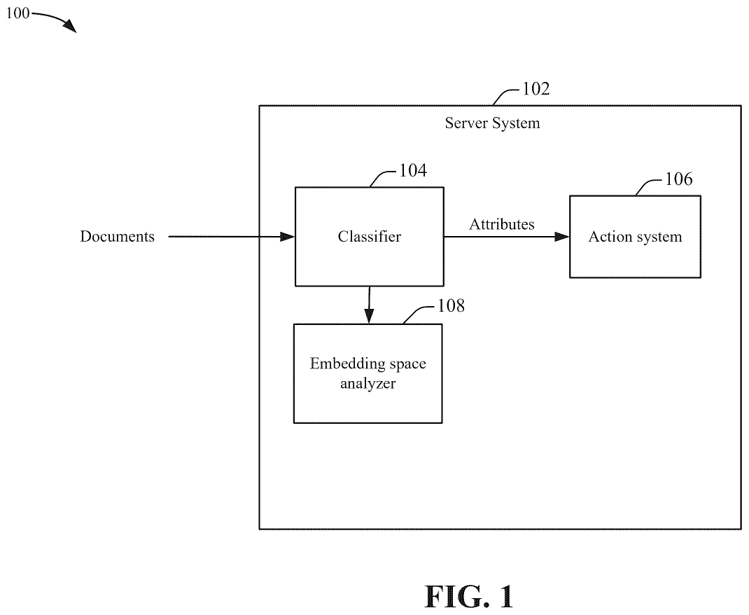

FIG. 1 depicts a simplified system 100 for analyzing instances of content according to some embodiments. System 100 includes a server system 102 that includes a classifier 104, an action system 106, and an embedding space analyzer 108.

Classifier 104 may receive documents for instances of content. The document may include text. In some embodiments, the instance of content may be media content (e.g., a movie, show, any video, etc.). The document may be based on the media content, such as the document may be a screenplay that may be a written script for the instance of content, subtitles from a video, or other structured or unstructured content. The screenplay may include text that outlines the story of the content, includes dialogue, but may also provide direction (e.g., action statements) for actors, directors, or include other information. The screenplay may be used as an example, and other types of content may be analyzed, such as reviews or plot analysis of media content.

Classifier 104 may analyze the documents and output attributes that describe the documents. As discussed above, the attributes may include types of genres, plot, mood, attitudes, places, etc. Depending on the classification, different attributes may be output, such as the output for the attribute of genre may include a type of drama, comedy, action, etc. In some embodiments, classifier 104 may be executed for each category of attribute. That is, classifier 104 may include different instances that are trained for specific category types. For example, a first classifier is trained to analyze the documents to determine attributes for a category of genre, a second classifier is trained to analyze the documents to determine attributes for a category of attitudes, etc.

An action system 106 may use the attributes to perform an action. For example, action system 106 may store the attributes as metadata for the document. The metadata may be used by various applications. For example, action system 106 may set up different representations such as a directed acyclic knowledge graph based on the attributes. Also, action system 106 may use the attributes to insert supplemental content during the display of a video associated with the document. For example, supplemental content that is related to the attributes of a scene may be selected and inserted. Further, action system 106 may determine recommendations based on the attributes. For example, when a user is interested in attributes associated with the instance of content for the document, the instance of content may be recommended. Action system 106 may also provide insights into the documents, such as the attributes may capture emotional and genre shifts that provide insights into the narrative dynamics and emotional intensity levels. Other actions may also be appreciated.

An embedding space analyzer 108 may analyze the embeddings in the embedding space. For example, embedding space analyzer 108 may determine semantic connections between various documents based on embeddings in the embedding space. Relationships may be used to manipulate an embedding of a document. The resulting embedding may then be associated with an embedding of another document. This may provide a semantic relationship between the two documents. The use of the embedding space may provide interesting relationships between documents that may not have been recognizable.

The following will now describe the structure of classifier 104 in more detail.

### Classifier

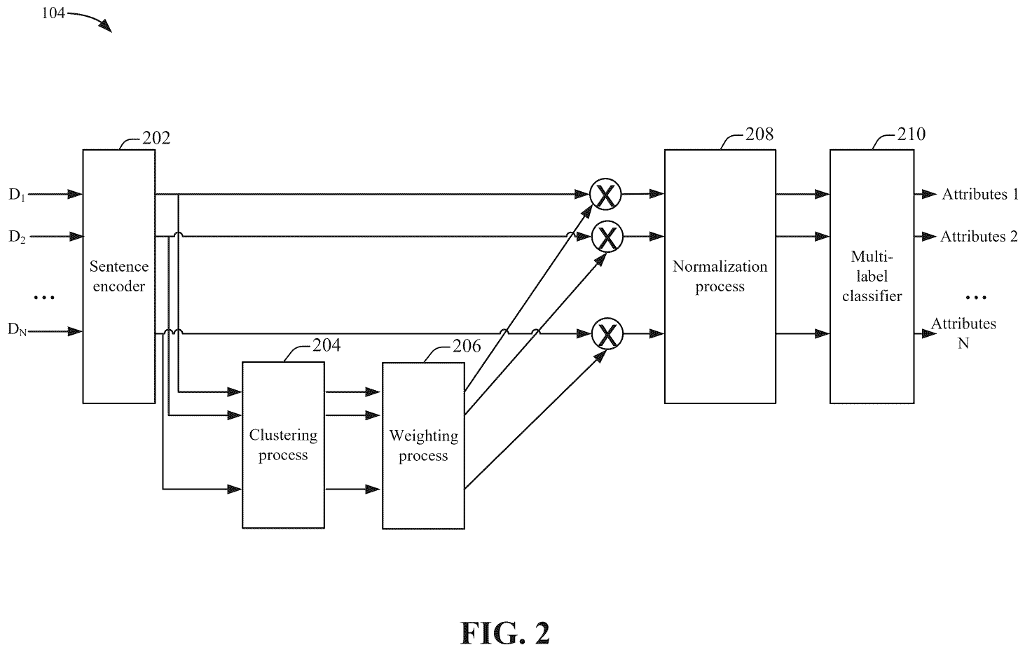

FIG. 2 depicts a more detailed example of classifier 104 according to some embodiments. A document may be associated with a screenplay. Then, the document may be segmented into segments s₁, s₂, . . . , sₙ. Each segment may include one or more sentences or paragraphs from the document. The segmentation may be performed differently, such as X number of sentences may be determined from the document, scenes, paragraphs, or other portions may be determined from the document as segments. Different documents may be segmented differently. For example, screenplays may have scenes that are of different lengths, and the segments may be different lengths for the respective documents.

A sentence encoder 202 receives the segments for multiple documents D₁, D₂, . . . , Dₛ as input. Each document includes respective segments. Sentence encoder 202 generates embeddings in an embedding space. The embedding space may be a continuous high-dimensional vector space. The embeddings may be embedding vectors, which may be a vector of numbers for the dimensions of the embedding space. In the space, embeddings that have similar meanings, features or patterns may be closer together and those that are different are placed further apart.

The following may be performed for each document. The generation of embeddings may be performed at different times. For example, once the embeddings are generated for a document, system 100 may not need to generate the embeddings again if the document does not change. When a new document is received, the already generated embeddings may be used for other documents, and the embeddings for the new document may just be generated. In some embodiments, each embedding may be a fixed length embedding vector of a dimension d of the embedding space. The entirety of the document may be represented in a matrix format where each row of the matrix corresponds to an embedding vector of a specific segment within the document. For example, the segments of a document are processed by sentence encoder 202 (U) to generate fixed-length embedding vectors

$$\{ {u}_{j}^{i} ∈ {R}^{d} \vert 1 \leq j \leq {N}_{i} \}$$

with d representing the dimension of the embedding space and j being the segment index/row index. Consequently, the entirety of document Dᵢ is represented in a matrix format Uᵢ where each row of this matrix corresponds to the embedding vector of a specific segment within the document.

One method to compute a document embedding vector for the entire document may be averaging the embedding vectors for the segments, which suggests that each segment equally influences the overall document representation. However, given the characteristics of a document, the averaging of the embedding vectors may not provide an accurate representation. For example, a document may include portions, such as scenes, that may not equally influence the characterization of attributes. For example, some scenes may be very important to attributes, such as the attitudes or plot, but some scenes may not be that important. To capture the differences in importance, a clustering process 204 may be performed to cluster the embeddings into clusters. The embedding space may be a continuous space, but a weighting of segments should be performed in a discrete space. Clustering process 204 may transition embeddings from a continuous space into a discrete space that is limited to cluster indices. For example, clustering process 204 may perform a union of all embeddings from the documents and categorizes each embedding into one of k clusters, wherein k may be a set parameter (e.g., 10, 20, 50, etc. clusters). The output of clustering process 204 may be the assigned cluster index of a segment j within a document. For example, the corresponding row j of the embedding matrix may be associated with an assigned cluster index.

A weighting process 206 may be performed based on the frequency of occurrence of the clusters in the documents. The system uses segment entropy, such as inverse document frequency, as a method of weighting, enabling a more refined adjustment of each segment's contribution based on its unique content. The entropy may be based on the frequency of occurrence of the cluster in the documents. For example, inverse document frequency (IDF) may be used. The inverse document frequency weighting may measure the importance of a segment in the document relative to a corpus of documents, where the corpus of documents may be the inputted documents to classifier 104. The weight may be adjusted considering how common or rare a segment is across the entire corpus. IDF weighting may be based on the concept that if segments appear in many documents, these segments may have less importance because the segments do not help distinguish one segment from another. Also, segments that are very rare may also not help distinguish one segment from another. However, segments that appear in only a few documents (above the very rare threshold but below the very common threshold) may have a higher weight indicating that the segment is more distinctive and important for the documents. Although IDF is described, other weighting processes that are based on the frequency of terms may also be used, such as Entropy weighting.

In the embedding space, embeddings may not be exactly the same due to the high number of dimensions and how much screenplays may differ. For example, scenes for screenplays may not be exactly the same, which results in slightly different embeddings. However, clustering may cluster together multiple segments that may be similar. The segments in the cluster may be assigned a single weight. This clustering process may improve the processing efficiency by treating multiple segments as a single segment for weighting purposes. In this case, there may be similar scenes that may be captured by the clustering.

Weighting process 206 determines the weighting value for each associated cluster index. The weights may be determined based on an inverse frequency of occurrence of segments in clusters. For example, a union of all embedded vectors

$${U}_{i = 1}^{S} {U}_{j = 1}^{{N}_{i}} {u}_{j}^{i}$$

is performed and clustering process 204 categorizes each vector into one of k clusters. This step effectively transitions the embedding from a continuous space into a discrete domain represented by cluster indices. Consequently, the clustering outcome for document i is expressed as

$${c}_{i} = ( {c}_{1}^{i} , {c}_{2}^{i} , … , {c}_{{N}_{i}}^{i} ) ,$$

where

$${c}_{j}^{i}$$

∈{1, 2, . . . , k} indicates ule assigned cluster index of segment j within document i, corresponding to the row j of the embedding matrix Uᵢ. the frequency of a cluster across all documents is denoted by fₘ={∀i, 1≤i≥S, m∈cᵢ}|, where S is a segment, m is the cluster index (e.g., 1 to k), fₘ is the number of documents that have a cluster m, the range of fₘ is initially between 1 and S (total number of documents) but then it is changed to between dfₘᵢₙ and dfₘₐₓ. The IDF for each cluster is calculated as follows:

$${g}_{m} = \{ \begin{matrix}log ( \frac{1 + S}{1 + {f}_{m}} ) & {df}_{min} \leq {f}_{m} \leq {df}_{max} \\ & or \\ 0 & otherwise\end{matrix}$$

Here, dfₘᵢₙ and dfₘₐₓ represent the lower and upper thresholds for document frequency, respectively. The threshold dfₘₐₓ is a maximum threshold in which clusters with a frequency below and dfₘᵢₙ is a minimum threshold in which clusters falling above meet the threshold. That is, clusters falling outside this range are ignored by assigning their weight value to 0, which effectively causes the weighted embedding to be 0. This approach filters out clusters that are either too common, or too rare, thereby not contributing significantly to the inference of attributes across the document set. These thresholds may be treated as hyperparameters and optimized during the training stage using cross-validation to ensure the best performance. In general, if a cluster appears in many documents, but is slightly lower than the maximum threshold, the weighting value may be low, meaning the segment is not very informative. If a cluster appears in a few documents, but is slightly higher than the minimum threshold, its weighting value may be high, meaning it is more distinctive.

Each cluster index is converted into weights. For example, if a segment #1 was associated with a cluster index #3, then the associated weight with cluster #3 is determined and assigned to segment #1. Then, each segment may be associated with a weight. For example, each cluster vector cᵢ is converted into

$${g}_{i} = ( {g}_{1}^{i} , {g}_{2}^{i} , … , {g}_{{N}_{i}}^{i} ) ,$$

which represents the weights for respective embeddings of a document. When these weight vectors are multiplied by their corresponding embedding matrices Uᵢ, a d-dimensional vector is produced. A matrix multiplication (or Matrix-Vector multiplication) between the embedding matrix and the weight vector applies the weight to respective embeddings of the segments to form weighted embeddings. The resulting vector may be the weighted average of the embedding rows within Uᵢ.

In some embodiments, to ensure that the final embeddings are standardized for consistent comparisons, a normalization process 208 may normalize the weighted embeddings, such as using an L2 normalization. This results in a normalized vector that serves as a comprehensive representation of the entire document, which captures its content and narrative elements in a dense numerical format. The normalization may be optionally performed.

A multi-label classifier 210 may classify the normalized weighted vector. For example, multi-label classifier 210 outputs attributes based on the normalized weighted vector. In some embodiments, multi-label classifier 210 may select an attribute for a category type, such as multi-label classifier 210 selects drama in the type of genre from possible attributes of drama, comedy, action, etc. In other embodiments, multi-label classifier 210 may output probabilities for every possible attribute. Then, attributes with probabilities that meet a threshold may be assigned to the document. For example, attributes with a probability over 70% may be assigned to the document. For each attribute type (e.g., genres, plot, mood, attitudes, places, etc.), a multi-label classifier may be trained. That is, three instances of multi-label classifier 210 may be used to determine attributes for genres, plot, mood, attitudes, places, etc. In other embodiments, a single multi-label classifier 210 may output attributes for multiple category types. Multi-label classifier 210 may be trained to output attributes based on embeddings. The training will be discussed in more detail below.

### Sentence Encoder

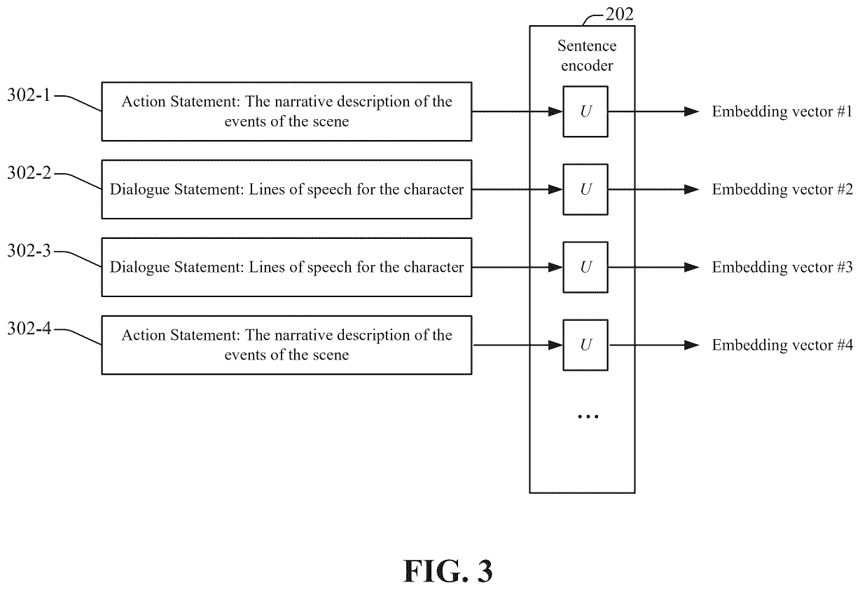

FIG. 3 depicts a more detailed example of sentence encoder 202 according to some embodiments. Sentence encoder 202 may receive segments 302-1, 302-2, 302-3, 302-4. Each segment may include one or more sentences from the document. For example, segment 302-1 may include an action statement that is a narrative description of the events of the scene. Segments 302-2 and 302-3 may include dialogue statements that may be lines of speech for a character. The dialogue may be different in the segments. Segment 302-4 may be an action statement that is a narrative description of the events of the scene. Other segments may also be appreciated that describe portions of the document.

Sentence encoder 202 may generate embeddings

$$\{ {u}_{j}^{i} ∈ {R}^{d} \vert 1 \leq j \leq {N}_{i} \} ,$$

with d representing the dimension of the embedding space for each segment 302-1 to 302-4 and j identifying the segments. For example, sentence encoder 202 outputs embedding vectors #1, #2, #3, #4, respectively. The embedding vectors represent the respective segments in the embedding space. The different content of segments 302-1 to 302-4 may result in different values for the embeddings in the embedding space.

The following will now describe the weighting process in more detail.

### Weighting Process

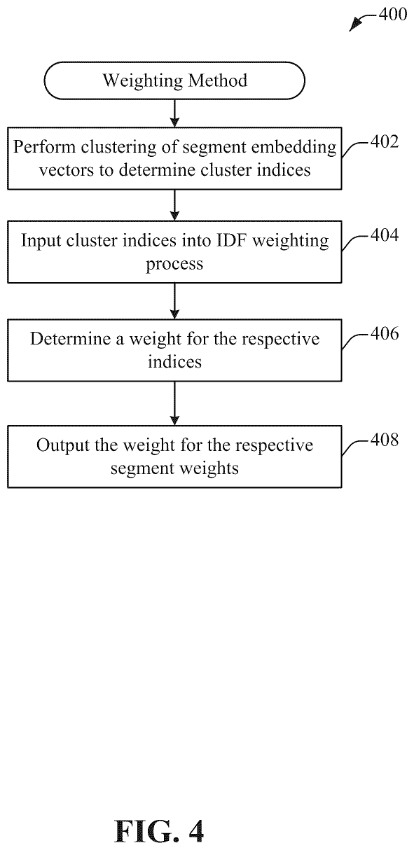

FIG. 4 depicts a simplified flowchart 400 of the weighting process according to some embodiments. At 402, clustering process 204 performs clustering of segment embedding vectors. Here, each segment may be associated with a cluster index. Then, at 404, the cluster indices are input into IDF weighting process 206.

At 406, weighting process 206 determines weights for the respective indices. For example, weighting process 206 may determine the frequency of occurrence of respective cluster indices in the document corpus. The weights may be inversely based on the frequency of occurrence. At 408, weighting process 206 outputs the respective segment weights.

### Semantic Relationships

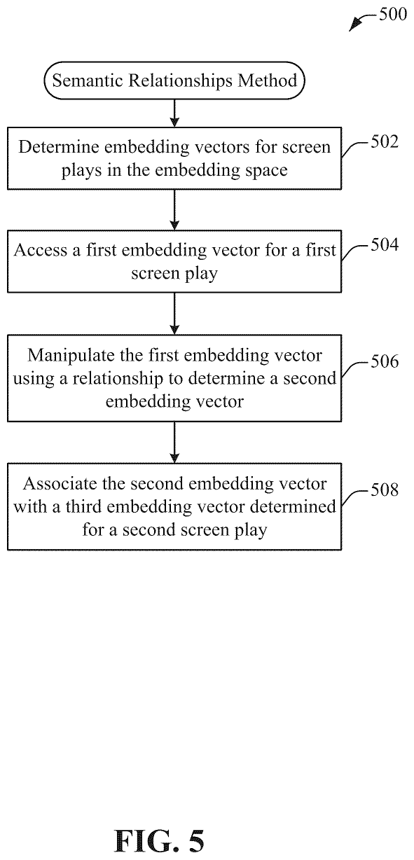

The embedding space may be used to determine semantic relationships between documents. FIG. 5 depicts a simplified flowchart 500 of an example using the embeddings for determining semantic relationships according to some embodiments. At 502, embedding space analyzer 108 determines embedding vectors for documents in the embedding space. An embedding vector may be associated with a document based on the weighted embedding vectors of the segments. For example, a first document may be associated with a first embedding vector and a second document may be associated with a second embedding vector. Also, embedding vectors for portions of the document may be used, such as an embedding vector for a scene.

At 504, embedding space analyzer 108 accesses a first embedding vector for a first document. The first embedding vector may be selected by a user, randomly determined, or selected based on criteria. At 506, embedding space analyzer 108 manipulates the first embedding vector using a relationship to determine a second embedding vector. For example, the relationship may be to subtract an embedding vector and then add an embedding vector to the first embedding vector. This results in a second embedding vector in the embedding space. Other relationships may also be determined. The relationship may be determined based on analyzing embedding vectors in the embedding space. Also, a standard set of relationships may be used. For example, one relationship may be subtract an embedding vector for “man” and add an embedding vector for “woman”.

At 508, embedding space analyzer 108 associates the second embedding vector with an embedding vector determined for a second document. For example, embedding space analyzer 108 may analyze the embedding space to determine the closest embedding vector to the second embedding vector. Also, embedding space analyzer 108 may use a threshold to determine a third embedding vector that is within the threshold. Although a third embedding vector is described, different numbers of embedding vectors may be selected, such as a set of embedding vectors that are within a threshold. In one example, the first embedding vector may be related by the relationship to the third embedding vector. This provides some relationships between the two documents using relationships in the embedding space.

In some embodiments, the system maintains the semantic connections between various storylines, as demonstrated by vector calculations capable of converting the character or genre embeddings from one scenario to another. For instance, the transformation from the screenplay embedding of a “Male Superhero” movie to that of a “Female Superhero” movie mirrors the semantic relation between the embedding of the word “Man” to “Woman”. This feature highlights the advanced understanding of narrative components and introduces a novel approach for the analysis, comparison, and adaptation of stories within the realm of artificial intelligence. This property makes the raw output document vector a valuable feature for many other machine learning applications, such as recommender systems. Here, the first movie may be related to a second movie based on relationship of subtracting an embedding for a woman and adding an embedding for a man. In other examples, the first movie may be associated with a second movie by subtracting a country and adding another country. The use of the embedding space may improve the relationships. For example, the embedding space is created by the same pre-trained embedding model through encoding each scene and document (e.g., screenplay). Clustering the scene embeddings with IDF weighting helps the documents find subtle relationships among each other because of the scenes that are assigned to the same clusters. This makes it possible for embedding space to determine the relationships that are not readily apparent outside of the embedding space.

### Training

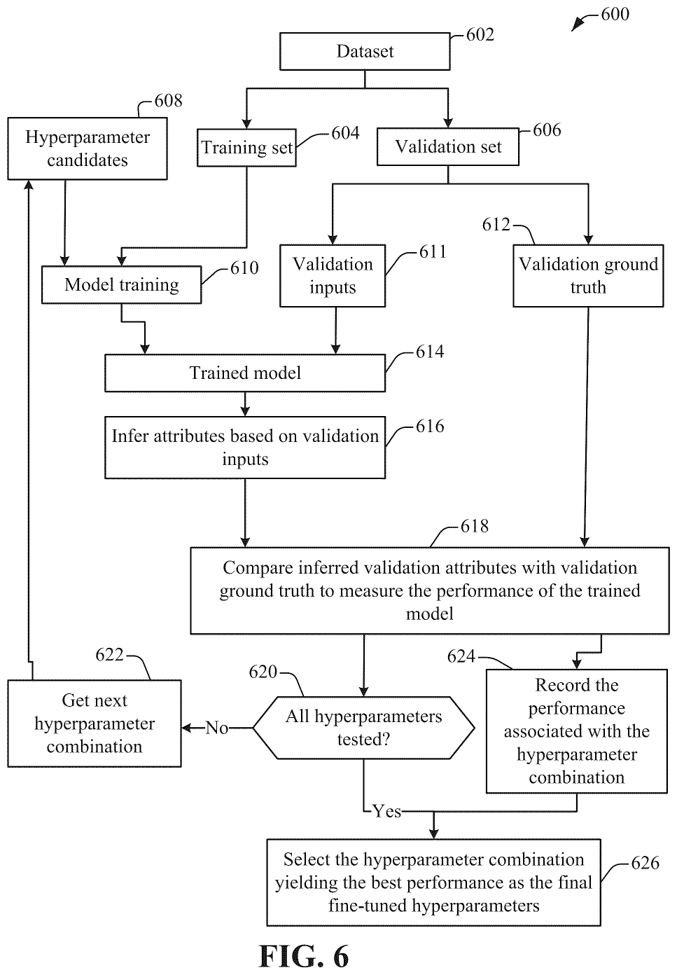

FIG. 6 depicts a simplified flowchart 600 for training hyperparameters of system 100 according to some embodiments. System 100 may have different parameters, such as model parameters and hyperparameters. Model parameters may be internal variables that the model itself learns from the training data. During training, an optimization algorithm automatically adjusts these parameters to minimize the model's errors and improve its predictions. Hyperparameters may be settings that control the model's architecture and training process.

In some embodiments, hyperparameters of clustering process 204 and multi-label classifier 210 may be trained in the training process. In some embodiments, sentence encoder 202 may not need to be trained, which may reduce the computing resources that are needed. This may make system 100 more efficient but also more accessible by requiring less computational resources due to not having to train sentence encoder 202. However, training of sentence encoder 202 may also be performed.

Unlike model parameters, hyperparameters are not learned directly from the data. They are typically set manually and require careful tuning. Hyperparameter tuning is the process of searching for the best hyperparameter values, that uses a technique called cross-validation. In cross-validation, at 602, a dataset is determined. The training set may include documents and also a ground truth of attributes for the documents. The data set is split into a training dataset at 604. The training data is divided into multiple subsets (e.g., multi-fold cross-validation). At 606, a validation set is determined. The validation set may include labels (attributes) in the training dataset that are called the “Ground Truth” and they teach the system and ensure accuracy.

At 608, hyperparameter candidates are determined, which may be different combinations of values of hyperparameters. The hyperparameters may include cluster size, minimum and maximum document frequency, or other hyperparameters. At 610, the model is trained on a portion of the data. Then, at 614, the trained model is evaluated on the remaining subset of validation inputs at 611. For example, at 616, the trained model infers attributes based on the validation inputs. At 618, the system compares inferred validation attributes with validation ground truth from 612 to measure the performance of the trained model. At 624, the system records the performance associated with the hyperparameter combination

This process is repeated multiple times, each time with a different combination of hyperparameters. For example, at 620, the system determines if all hyperparameters have been tested. If not, at 622, the system determines a next hyperparameter combination. The process proceeds to be performed again.

At 626, the system selects the hyperparameter combination yielding the best performance as the final fine-tuned hyperparameters. The hyperparameters of multi-label classifier 210, the minimum and maximum document frequency thresholds, or cluster size may be optimized using a difference between the attributes output by system 100 and the ground truth. The maximum and minimum document frequency thresholds may be adjusted to determine which clusters to ignore from the analysis. For example, the minimum document frequency threshold indicates the cluster is too rare and the maximum document frequency threshold indicates that the cluster is too common. Segments within clusters that do not meet the thresholds may be ignored in that the segments are not weighted and the respective embeddings do not contribute to the classification. Also, different values of clustering size may be adjusted based on the performance of system 100. For example, the clustering size may be increased or decreased based on the performance. In some embodiments, the cluster size may be adjusted and tuned to adjust to the size of scenes in the documents. For example, if the size of the scenes is small, the number of segments will be large. Larger number of clusters may be used, which may result in smaller cluster sizes. On the other hand, if the scene sizes are large, then a constraint on the number of clusters may be used, which may result in larger cluster sizes. However, the hyperparameter toning attempts to find the optimum number of clusters from both computational and performance perspectives.

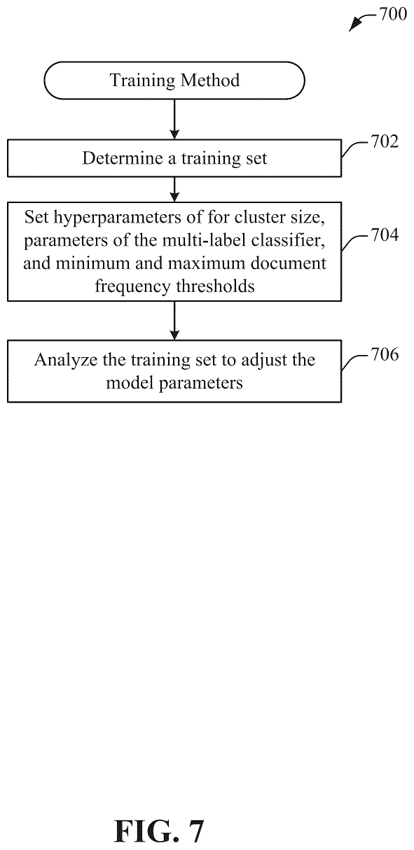

Once the optimal hyperparameters are determined, the model is trained on the entire training dataset using the fined-tuned hyperparameters. During this final training phase, the model parameters are automatically learned by an optimization algorithm. FIG. 7 depicts a simplified flowchart 700 for training model parameters of system 100 according to some embodiments. In some embodiments, model parameters of clustering process 204 and multi-label classifier 210 may be trained in the training process. In some embodiments, sentence encoder 202 may not need to be trained, which may reduce the computing resources that are needed. This may make system 100 more efficient but also more accessible by requiring less computational resources due to not having to train sentence encoder 202. However, training of sentence encoder 202 may also be performed.

At 702, a training set is determined. The training set may include documents and also a ground truth of attributes for the documents. The labels (attributes) in the training dataset are called the “Ground Truth” and they teach the system and ensure accuracy. Machine learning models learn by identifying patterns in data. The “ground truth” provides the system with the correct answers (the desired attributes) for a set of documents. This allows the model to learn the relationships between the features of the input documents and their corresponding attributes. The “ground truth” refers to accurate and verified information that is used in training. It also acts as a benchmark. By comparing the model's predictions with the actual “ground truth” data, the system can assess its accuracy and identify areas for improvement. This ensures that the model is reliable and produces meaningful results.

At 704, hyperparameters for cluster size and the multi-label classifier 210 may be set. These hyperparameters may be set during the process described above in FIG. 6. The hyperparameters may be the minimum and maximum document frequency thresholds for the clustering process, the number of clusters, or the parameters of multi-label classifier 210 that are used to determine the attributes.

At 706, the training set is analyzed by system 100 to adjust the model parameters. For example, the model parameters of may be adjusted to minimize a loss between a difference of the attributes and the ground truth.

### CONCLUSION

Accordingly, a long document may be analyzed to determine attributes in an efficient manner. A dense vector representation of the entire text may preserve semantic relatedness, which makes the vector valuable in representing the documents for other systems. An enhanced accuracy in metadata extraction for the attributes is performed via a classifier that is applied to embeddings. Also, automated scene level detection of metadata may be used by other systems that require scene level information, such as when supplemental content is inserted in between scenes.

In some embodiments, the system automatically extracts media content metadata attributes such as genres, plot, mood, attitudes, places, etc., and provides an efficient, accurate, and insightful approach to understand and predict content details, which is crucial when considering the different applications. For example, the attributes may be used in metadata identification, attribution enrichment, and attribute extraction in upstream databases, such as text content, knowledge graphs, as well as knowledge databases. In some embodiments, content metadata can be enriched and enhanced based on their embeddings to set up a directed acyclic knowledge graph. The attributes may be used in supplemental content insertion automation based on a specific scene attribute or the flow of the scene. For instance, video supplemental content insertion within movies and TV series is performed based on the semantic relationships between the supplemental content and the scene. The attributes may be used in down-stream applications, such as recommendation systems, sentiment analysis, scene/content segmentation, content understanding as well as other data science and machine learning applications. For instance, the semantic relationships generated from the embeddings across different media content can be efficiently applied for product recommendation systems in the realm of digital media. The system may reduce unintended biases and errors in manual attribute tagging that occur due to human subjectiveness and repetitive work. The attributes may be used in content quality measurement and identification. For example, the capability of extracting streaming content attributes at the scene level helps to distinguish successful screenplays. Capturing the emotional and genre shifts provides deep insights on the narrative dynamics and emotional intensity levels throughout a streaming content. As the audience engages and is attracted to emotionally intense scripts, defining the ups and downs is a great identifier for the successful screenplays.

Also, the system is computationally efficient. The traditional approach requires training the neural network or encoder network, which is computationally expensive. Instead of training neural networks, the system may leverage pre-trained language models, this utilization of pre-trained language models for generating initial paragraph embeddings significantly reduces the computational burden and the necessity for extensive hardware. However, the system may train models for its purpose. Other advantages include enhanced accuracy in attribute prediction and preserving semantic relatedness among individual scenes and screenplays.

### System

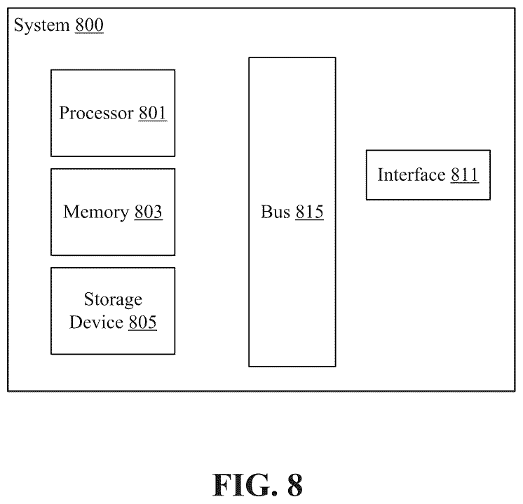

FIG. 8 illustrates one example of a computing device according to some embodiments. According to various embodiments, a system 800 suitable for implementing embodiments described herein includes a processor 801, a memory 803, a storage device 805, an interface 811, and a bus 815 (e.g., a PCI bus or other interconnection fabric.) System 800 may operate as a variety of devices, or any other device or service described herein. Although a particular configuration is described, a variety of alternative configurations are possible. The processor 801 may perform operations such as those described herein. Instructions for performing such operations may be embodied in the memory 803, on one or more non-transitory computer readable media, or on some other storage device. Various specially configured devices can also be used in place of or in addition to the processor 801. Memory 803 may be random access memory (RAM) or other dynamic storage devices. Storage device 805 may include a non-transitory computer-readable storage medium holding information, instructions, or some combination thereof, for example instructions that when executed by the processor 801, cause processor 801 to be configured or operable to perform one or more operations of a method as described herein. Bus 815 or other communication components may support communication of information within system 800. The interface 811 may be connected to bus 815 and be configured to send and receive data packets over a network. Examples of supported interfaces include, but are not limited to: Ethernet, fast Ethernet, Gigabit Ethernet, frame relay, cable, digital subscriber line (DSL), token ring, Asynchronous Transfer Mode (ATM), High-Speed Serial Interface (HSSI), and Fiber Distributed Data Interface (FDDI). These interfaces may include ports appropriate for communication with the appropriate media. They may also include an independent processor and/or volatile RAM. A computer system or computing device may include or communicate with a monitor, printer, or other suitable display for providing any of the results mentioned herein to a user.

Any of the disclosed implementations may be embodied in various types of hardware, software, firmware, computer readable media, and combinations thereof. For example, some techniques disclosed herein may be implemented, at least in part, by non-transitory computer-readable media that include program instructions, state information, etc., for configuring a computing system to perform various services and operations described herein. Examples of program instructions include both machine code, such as produced by a compiler, and higher-level code that may be executed via an interpreter. Instructions may be embodied in any suitable language such as, for example, Java, Python, C++, C, HTML, any other markup language, JavaScript, ActiveX, VBScript, or Perl. Examples of non-transitory computer-readable media include, but are not limited to: magnetic media such as hard disks and magnetic tape; optical media such as flash memory, compact disk (CD) or digital versatile disk (DVD); magneto-optical media; and other hardware devices such as read-only memory (“ROM”) devices and random-access memory (“RAM”) devices. A non-transitory computer-readable medium may be any combination of such storage devices.

In the foregoing specification, various techniques and mechanisms may have been described in singular form for clarity. However, it should be noted that some embodiments include multiple iterations of a technique or multiple instantiations of a mechanism unless otherwise noted. For example, a system uses a processor in a variety of contexts but can use multiple processors while remaining within the scope of the present disclosure unless otherwise noted. Similarly, various techniques and mechanisms may have been described as including a connection between two entities. However, a connection does not necessarily mean a direct, unimpeded connection, as a variety of other entities (e.g., bridges, controllers, gateways, etc.) may reside between the two entities.

Some embodiments may be implemented in a non-transitory computer-readable storage medium for use by or in connection with the instruction execution system, apparatus, system, or machine. The computer-readable storage medium contains instructions for controlling a computer system to perform a method described by some embodiments. The computer system may include one or more computing devices. The instructions, when executed by one or more computer processors, may be configured or operable to perform that which is described in some embodiments.

As used in the description herein and throughout the claims that follow, “a”, “an”, and “the” include plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of some embodiments may be implemented. The above examples and embodiments should not be deemed to be the only embodiments and are presented to illustrate the flexibility and advantages of some embodiments as defined by the following claims. Based on the above disclosure and the following claims, other arrangements, embodiments, implementations, and equivalents may be employed without departing from the scope hereof as defined by the claims.

1. A method comprising:
determining embeddings in an embedding space for segments of a plurality of documents;
determining a cluster for respective segments based on a set of clusters, wherein the cluster is determined based on a position of respective embeddings in the embedding space;
determining a weight for the cluster for respective embeddings;
weighting the respective embeddings for a document in the plurality of documents using the weight of the cluster for the respective embeddings to generate weighted embeddings; and
determining a set of attributes from the weighted embeddings for the document.

2. The method of claim 1, wherein determining the embeddings comprises:
inputting a segment of the document into an encoder; and
outputting an embedding in the embedding space based on the segment.

3. The method of claim 2, wherein the embedding comprises an embedding vector that represents content of the segment a set of dimensions in the embedding space.

4. The method of claim 1, wherein:
the document comprises a screenplay for content, and
the screenplay includes text based on the content.

5. The method of claim 1, wherein determining the cluster for respective segments comprises:
comparing a position of an embedding in the embedding space to positions of one or more clusters; and
selecting a cluster based on the comparing.

6. The method of claim 1, wherein determining the cluster for respective segments comprises:
clustering embeddings for the plurality of documents to determine the set of clusters.

7. The method of claim 6, wherein the weight of the cluster for respective segments is based on a frequency of occurrence of the respective embeddings in the plurality of documents compared to other clusters in the set of clusters.

8. The method of claim 6, wherein:
a first threshold of frequency that is used to ignore any clusters that occur less than the first threshold, and
a second threshold of frequency that is used to ignore any clusters that occur more than the second threshold.

9. The method of claim 6, wherein a number of clusters in the set of clusters is a setting.

10. The method of claim 1, wherein weighting the respective embeddings using the weight for the cluster comprises:
applying the weight for a respective cluster to the respective embedding.

11. The method of claim 1, wherein different clusters are associated with different weights based on a frequency of occurrence of the cluster in the plurality of documents compared to other clusters in the set of clusters.

12. The method of claim 1, wherein determining the attributes comprises:
using a classifier that classifies the weighted embeddings for the document into one or more attributes for the document.

13. The method of claim 1, wherein determining the attributes comprises:
using a plurality of classifiers that are respectively trained to classify the weighted embeddings for the document into an attribute in a respective type of attribute, wherein the type of attribute is associated with one of the plurality of classifiers.

14. The method of claim 1, further comprising:
performing training in which a parameter for a number of clusters is adjusted.

15. The method of claim 1, further comprising:
performing training in which a parameter of a classifier that classifies the weighted embeddings into the attributes for the document is adjusted.

16. The method of claim 1, further comprising:
performing training in which a first threshold of frequency that is used to ignore any segments that occur less than the first threshold and a second threshold of frequency that is used to ignore any segments that occur more than the second threshold are adjusted.

17. The method of claim 1, further comprising:
performing training in which a first parameter for a number of clusters is adjusted;
performing training in which a second parameter of a classifier that classifies the weighted embeddings into the attributes for the document are adjusted; and
performing training in which a first threshold of frequency that is used to ignore any segments that occur less than the first threshold and a second threshold of frequency that is used to ignore any segments that occur more than the second threshold are adjusted, wherein parameters of an encoder that determines the embeddings are not adjusted.

18. A non-transitory computer-readable storage medium having stored thereon computer executable instructions, which when executed by a computing device, cause the computing device to be operable for:
determining embeddings in an embedding space for segments of a plurality of documents;
determining a cluster for respective segments based on a set of clusters, wherein the cluster is determined based on a position of respective embeddings in the embedding space;
determining a weight for the cluster for respective embeddings;
weighting the respective embeddings for a document in the plurality of documents using the weight of the cluster for the respective embeddings to generate weighted embeddings; and
determining a set of attributes from the weighted embeddings for the document.

19. The non-transitory computer-readable storage medium of claim 18, further operable for:
performing training in which a first parameter for a number of clusters is adjusted;
performing training in which a second parameter of a classifier that classifies the weighted embeddings into the attributes for the document are adjusted; and
performing training in which a first threshold of frequency that is used to ignore any segments that occur less than the first threshold and a second threshold of frequency that is used to ignore any segments that occur more than the second threshold are adjusted, wherein parameters of an encoder that determines the embeddings are not adjusted.

20. An apparatus comprising:
one or more computer processors; and
a computer-readable storage medium comprising instructions for controlling the one or more computer processors to be operable for:
determining embeddings in an embedding space for segments of a plurality of documents;
determining a cluster for respective segments based on a set of clusters, wherein the cluster is determined based on a position of respective embeddings in the embedding space;
determining a weight for the cluster for respective embeddings;
weighting the respective embeddings for a document in the plurality of documents using the weight of the cluster for the respective embeddings to generate weighted embeddings; and
determining a set of attributes from the weighted embeddings for the document.
